(19) United States
(12) Patent Application Publication
(10) Pub. No.: US 2012/0297139 A1
(43) Pub. Date: Nov. 22, 2012

(54) MEMORY MANAGEMENT UNIT, APPARATUSES INCLUDING THE SAME, AND METHOD OF OPERATING THE SAME

(75) Inventor: JIN HYUCK CHOI, SEONGNAM-SI (KR)

(73) Assignee: SAMSUNG ELECTRONICS CO., LTD., SUWON-SI (KR)

(21) Appl. No.: 13/473,638

(22) Filed: May 17, 2012

(30) Foreign Application Priority Data
May 20, 2011 (KR) 10-2011-0048140

(51) Int. Cl. G06F 12/08; G06F 12/10

(52) U.S. Cl. 711/122; 711/207; 711/E12.024; 711/E12.061

(57) ABSTRACT

A method of operating a memory management unit includes accessing a translation lookaside buffer (TLB), translating a page number of a virtual address into a frame number of a physical address when there is a match for the page number of the virtual address in the TLB, executing a miss process when there is no match for the page number of the virtual address in the TLB. The miss process includes accessing a page table translation (PTT) cache, checking whether access information of a k-th level page table corresponding to a k-th page number that will be accessed in the virtual address is in the PTT cache, acquiring a base address of a physical page using the access information, and determining the frame number of physical address corresponding to the page number of the virtual address using a page offset in the physical page.

### CROSS-REFERENCE TO RELATED APPLICATIONS

This application claims priority under 35 U.S.C. §119(a) from Korean Patent Application No. 10-2011-0048140 filed on May 20, 2011, the disclosure of which is hereby incorporated by reference in its entirety.

### BACKGROUND

The inventive concept relates to an electronic device, referred to as memory management unit (MMU), which controls access to a data memory. The inventive concept also relates to electronic apparatus including an MMU, and to methods of operating an MMU and electronic apparatus including an MMU.

An MMU is a hardware component that processes memory access requests issued by a direct memory access unit such as a central processing unit (CPU). The MMU may also be referred to as a paged MMU (PMMU).

Generally, the MMU initially attempts to utilize an associative cache called a Translation Lookaside Buffer (TLB) to virtual page addresses to the physical page addresses of a memory, such as an instruction memory. If not physical page address match for a virtual page address is located in the TLB, then the TLB executes a slower process in which a page table is referenced to determine the necessary physical page address. This can delay channel activity of the MMU.

### SUMMARY

According to some embodiments of the inventive concept, a method of operating a memory management unit which accesses an N-level page table of a memory, where N is a plural integer, is provided. The method includes accessing a translation lookaside buffer (TLB), translating a page number of a virtual address into a frame number of a physical address when there is a match for the page number of the virtual address in the TLB, executing a miss process when there is no match for the page number of the virtual address in the TLB. The miss process includes accessing a page table translation (PTT) cache, checking whether access information of a k-th level page table corresponding to a k-th page number that will be accessed in the virtual address is in the PTT cache, where k is an integer and 1>k≧N, acquiring a base address of a physical page using the access information, and determining the frame number of physical address corresponding to the page number of the virtual address using a page offset in the physical page.

According to other embodiments of the inventive concept, a memory management unit which accesses an N-level page table of a memory, where N is a plural integer, is provided. The memory management unit includes a table lookaside buffer (TLB) configured to translate a page number of a virtual address into a frame number of a physical address when the TLB includes a match for the page number of the virtual address. The memory management unit further includes a page table translation (PTT) cache configured to provide access information of a k-th level page table corresponding to a k-th page number to enable a physical page including the physical address to be accessed when the TLB does not include a match for the page number of the virtual address, where k is an integer and 1>k≧N.

According to still other embodiments of the inventive concept, an electronic apparatus is provided which includes a central processing unit (CPU) configured to request an access to a virtual address for execution of a program sequence, a multi-level page table configured to store information indicative of a mapping between the virtual address and a physical address, and a memory management unit, where the memory management unit translates the virtual address into the physical address using an N-level page table, where N is a plural integer. The memory management unit includes a table lookaside buffer (TLB) configured to translate a page number of a virtual address into a frame number of a physical address when the TLB includes a match for the page number of the virtual address. The memory management unit further includes a page table translation (PTT) cache configured to provide access information of a k-th level page table corresponding to a k-th page number to enable a physical page including the physical address to be accessed when the TLB does not include a match for the page number of the virtual address, where k is an integer and 1>k≧N.

### BRIEF DESCRIPTION OF THE DRAWINGS

The above and other features and aspects of the inventive concept will become readily apparent from the detail description that follows, with reference to the accompanying drawings, in which:

FIG. 1 is a diagram of an electronic apparatus including a memory management unit (MMU) according to some embodiments of the inventive concept;

FIG. 2 is a block diagram of a processor illustrated in FIG. 1;

FIG. 3 is a diagram representative of a mapping between virtual addresses and physical addresses;

FIG. 4A is a detailed block diagram of the MMU illustrated in FIG. 2 according to some embodiments of the inventive concept;

FIG. 4B is a detailed block diagram of the MMU illustrated in FIG. 2 according to other embodiments of the inventive concept;

FIG. 5 is a conceptual diagram for explaining an operating principle of a page table translation (PTT) cache illustrated in FIGS. 4A and 4B according to some embodiments of the inventive concept;

FIG. 6 is a detailed block diagram of the PTT cache illustrated in FIGS. 4A and 4B;

FIG. 7A is a conceptual diagram for explaining an operating principle of the PTT cache illustrated in FIGS. 4A and 4B according to other embodiments of the inventive concept;

FIG. 7B is a conceptual diagram for explaining an operating principle of the PTT cache illustrated in FIGS. 4A and 4B according to further embodiments of the inventive concept;

FIG. 8 is a conceptual diagram for explaining an operating principle of the PTT cache illustrated in FIGS. 4A and 4B according to yet other embodiments of the inventive concept;

FIG. 9 is a flowchart for use in describing a method of operating the MMU illustrated in FIGS. 4A and 4B according to some embodiments of the inventive concept;

FIG. 10 is a flowchart for use in describing a method of operating the MMU that is illustrated in FIG. 7B;

FIG. 11 is a diagram of an electronic apparatus including the MMU illustrated in FIG. 1 according to other embodiments of the inventive concept; and

FIG. 12 is a diagram of an electronic apparatus including the MMU illustrated in FIG. 1 according to further embodiments of the inventive concept.

### DETAILED DESCRIPTION OF THE EMBODIMENTS

The inventive concept now will be described more fully hereinafter with reference to the accompanying drawings, in which embodiments of the inventive concept are shown. This inventive concept may, however, be embodied in many different forms and should not be construed as limited to the embodiments set forth herein. Rather, these embodiments are provided so that this disclosure will be thorough and complete, and will fully convey the scope of the inventive concept to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

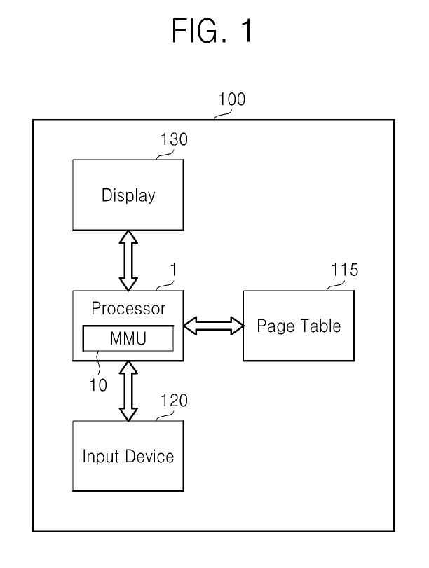

FIG. 1 is a diagram of an electronic apparatus 100 including a memory management unit (MMU) 10 according to some embodiments of the inventive concept.

Referring to FIG. 1, the electronic apparatus 100 may be implemented as any of a large array of electronics devices, examples including a personal computer (PC), a tablet PC, a netbook, an e-reader, a personal digital assistant (PDA), a portable multimedia player (PMP), an MP3 player and an MP4 player.

The electronic apparatus 100 includes a processor 1, a page table 115, an input device 120, and a display 130. The processor 1 includes a memory management unit (MMU) 10.

The processor 1, which includes a central processing unit (CPU), executes program instructions to control an overall operation of the electronic apparatus 100. For instance, the processor 1 may receive program instructions via the input device 120. In this case, the processor 1 executes program instructions by reading data from a memory (not shown in FIG. 1), and displaying the data on the display 130. The input device 120 is not limited, and examples thereof include a keypad, a keyboard, and point-and-touch devices such as a touch pad and a computer mouse.

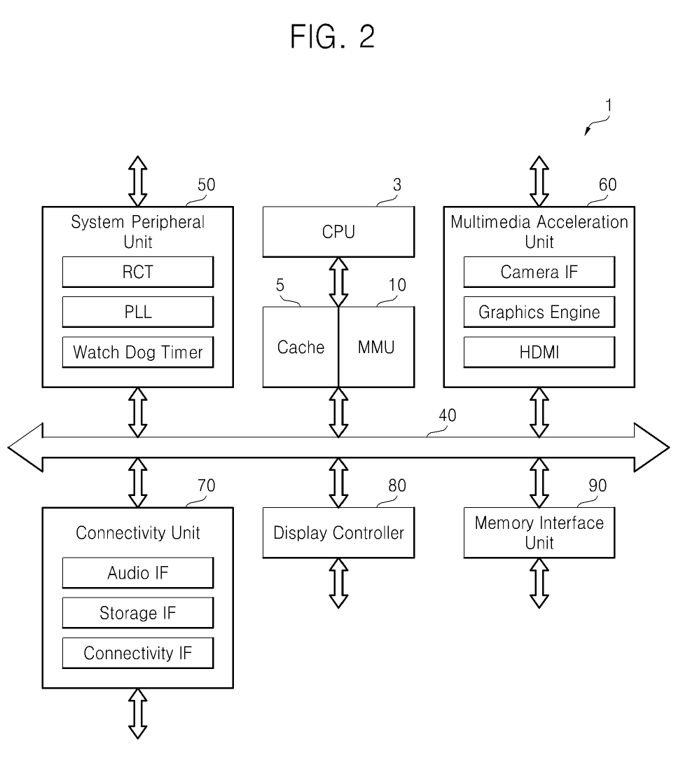

FIG. 2 is a block diagram showing an example of the processor 1 illustrated in FIG. 1.

Referring to FIGS. 1 and 2, the processor 1 of this example includes a central processing unit (CPU) 3, a cache 5, the MMU 10, a data bus 40, a system peripheral unit 50, a multimedia acceleration unit 60, a connectivity unit 70, a display controller 80, and a memory interface unit 90.

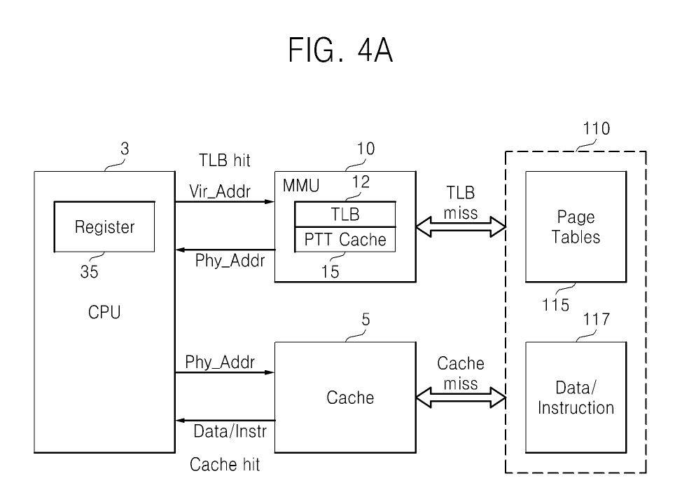

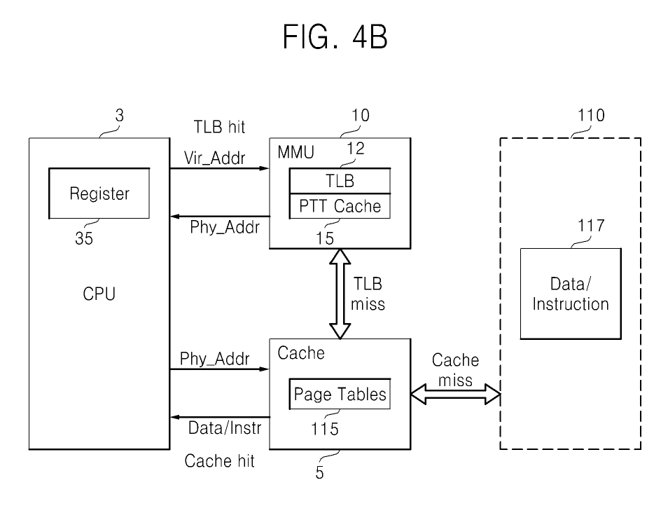

The CPU 3 executes received program instructions. The cache 5 is a high-speed memory which stores selected data, e.g., frequently accessed data, in order to reduce an average latency of memory access operations by the CPU 3. The MMU 10 is a hardware component which processes a request from the CPU 3 to access to a memory (e.g., the memory 110 shown in FIGS. 4A and 4B, described later).

MMU 10 functionality may include translating virtual addresses into physical addresses, memory protection, controlling the cache 5, bus arbitration, and/or bank switching.

The system peripheral unit 50, the multimedia acceleration unit 60, the connectivity unit 70, the display controller 80 and memory interface unit 90 communicate data or instructions with one another via a system bus 40.

The system bus 40 may include a plurality of channels, such as a read data channel, a read address channel, a write address channel and a write data channel.

The system peripheral unit 50 includes a real-time clock (RTC), a phase-locked loop (PLL) and a watch dog timer.

The multimedia acceleration unit 60 includes a graphics engine. Alternatively, the multimedia acceleration unit 60 may include a camera interface, a graphics engine integrated with a frame buffer performing graphic calculation or a video display circuitry, and a high-definition multimedia interface (HDMI) which is an audio/video interface for transmitting uncompressed digital data. It is noted here that the MMU 10 may be used to translate a virtual address output from the graphics engine into a physical address.

In other embodiments, the multimedia acceleration unit 60 may include an analog television encoding system, i.e., national television system committee (NTSC)/phase alternate line (PAL) in place of the HDMI, or in addition to the HDMI.

The connectivity unit 70 may include an audio interface, a storage interface like an advanced technology attachment (ATA) interface, and a connectivity interface. The connectivity unit 70 may communicate with the input device 120.

The display controller 80 controls data to be displayed in the display 130. The MMU 10 may be used to translate a virtual address output from the display controller 80 into a physical address.

The memory interface unit 90 enables the memory 110 to be accessible according to the type of memory (e.g., flash memory or dynamic random access memory (DRAM)).

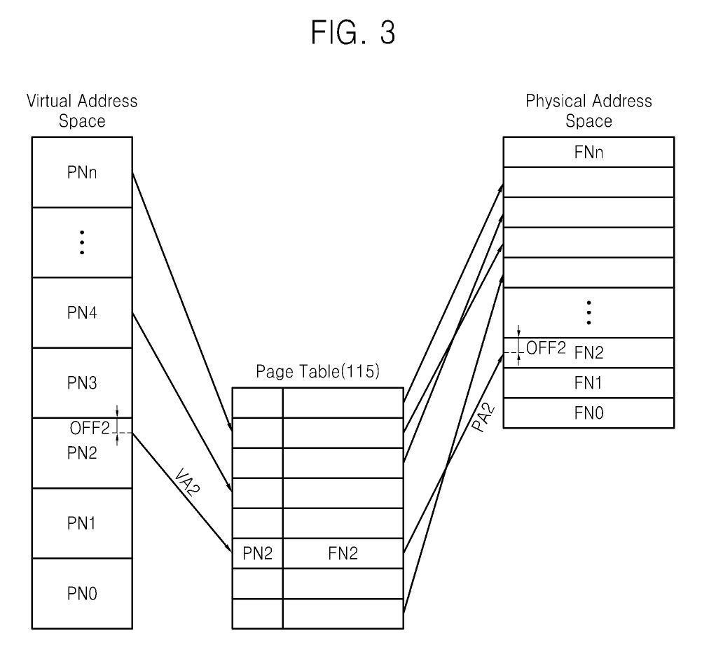

FIG. 3 is a diagram showing mapping between virtual addresses and physical addresses.

Referring to FIGS. 1 through 3, a virtual address space may be divided into a plurality of pages PN0 through PNn.

Each of the pages PN0 through PNn is a block of adjacent virtual addresses. Each of the pages PN0 through PNn has a given data size of, for example, 4 KB. However, the size of the pages PN0 through PNn is not limited and may be changed.

Like the virtual address space, a physical address space may be divided into a plurality of frames FN0 through FNn. Each of the frames FN0 through FNn has a fixed size.

A virtual address, e.g., VA2, includes a page number, e.g., PN2, and an offset, e.g., OFF2, within a page. In other words, the virtual address may be expressed by Equation 1:

VAi=PNj+OFFx (1)

where “i”, “j” and “x” are 1 or a natural number greater than 1, VAi is a virtual address, PNj is a page number, and OFFx is an offset.

The page number PN2 is used as an index in a page table 115.

The offset OFF2 is combined with a frame number, e.g., FN2, defining a physical address, e.g., PA2. The physical address may be expressed by Equation 2:

PAr=FNs+OFFx (2)

where “r”, “s” and “x” 1 or a natural number greater than 1, PAr is a physical address, FNs is a frame number, and OFFx is an offset. The page number PA2 may be referred to as a virtual page number and the frame number FN2 may be referred to as a physical page number.

The page table 115 contains a mapping between a virtual address of a page and a physical address of a frame. The page table 115 may be included in a separate memory (not shown) or in the cache 5.

FIG. 4A is a more detailed block diagram of the MMU 10 illustrated in FIG. 2 according to some embodiments of the inventive concept. FIG. 4B is a more detailed block diagram of the MMU 10 illustrated in FIG. 2 according to other embodiments of the inventive concept.

Referring to FIGS. 1 through 4A, the MMU 10 of this example includes a translation lookaside buffer (TLB) 12 and a table translation (PTT) cache 15 and is connected to the CPU 3 and the memory 110 through a plurality of channels, i.e., a read data channel (R), a read address channel (AR), a write address channel (AW), and a write data channel (W).

The MMU 10 calculates a physical page address using a virtual address VA to access the page table 115. The physical page address is obtained by combining the page number PN of the virtual address VA and an offset (e.g., a page table pointer), and is used as an index when the page table 115 is accessed.

The TLB 12 is memory management hardware used to increase a virtual address translation speed. The TLB 12 contains a mapping between a page number PN and a frame number FN. When translating a virtual address into a physical address, the MMU 10 checks the TLB 12 first. If requested mapping information is in the TLB 12 (which is called a TLB hit), the MMU 10 directly processes the translation without accessing the memory 110 and reading mapping information from the memory 110.

When no match is found in the TLB 12 between the page number PN and the frame number FN of the virtual address VA (which is called a TLB miss), a page table walk is carried out. The page table walk is a process of finding out whether the page number PN and the frame number FN of the virtual address VA are matched in the page table 115 stored in the memory 110 when they are not matched in the TLB 12. At this time, the page table 115 may be a multilevel (e.g., N-level where N is 2 or a natural number greater than 2) page table and may be implemented in various ways in different embodiments.

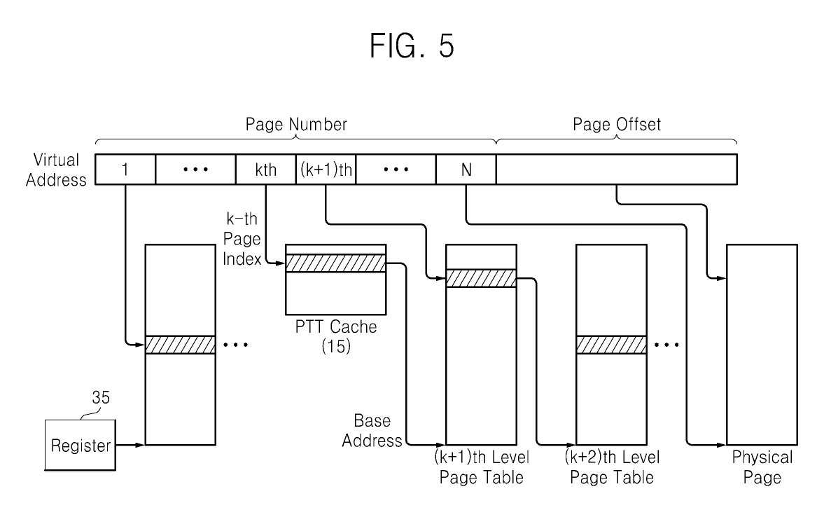

The PTT cache 15 is also memory management hardware used to increase the virtual address translation speed, but unlike the TLB 12, the PTT cache 15 stores information about a previous access to a multi-level page table 115. The PTT cache 15 stores access information regarding to the page table 115 in order to reduce overhead occurring with frequent access to the page table 115 during a page table walk. In other words, the access information in the PTT cache 15 is used when the page table 115 is accessed again, thereby reducing the overhead and increasing the virtual address translation speed. The detailed structure and operations of the PTT cache 15 will be described in detail later with reference to FIGS. 5 through 8.

In both the embodiments of FIG. 4A and FIG. 4B, the cache 5 is a component that reads data from a data/instruction block 117 included in the memory 110 using a physical address generated by the MMU 10 and stores the data. However, unlike the embodiment illustrated in FIG. 4A, the embodiment of FIG. 4B is characterized by the page table 115 being included in the cache 5. In this case, a page table walk is carried out between the MMU 10 and the cache 5.

FIG. 5 is a conceptual diagram for explaining the operation principle of the PTT cache 15 illustrated in FIGS. 4A and 4B according to some embodiments of the inventive concept.

The page table shown in FIG. 5 is a top-down hierarchical page table. When a program sequence requests the MMU 10 for the access of a virtual address through the CPU 3, the MMU 10 accesses the TLB 12 to translate the virtual address to a physical address. When translation information of the virtual address is not in the TLB 12, a page table walk is carried out.

The MMU 10 acquires a base address of a first level page table from a register 35. The MMU 10 calculates page numbers at different levels respectively from upper bits of the virtual address and acquires a base address of each of second through N-th level page tables.

When the MMU 10 calculates the page numbers at the different levels respectively from the upper bits of the virtual address and acquires the base address of each of the second through N-th level page tables for the first time, the PTT cache 15 stores access information of each page table level.

For instance, when a k-th page number is used, it is checked whether access information to which the k-th page number is mapped is in the PTT cache 15. When the access information matching the k-th page number is in the PTT cache 15, the base address of a (k+1)-th level page table is acquired from the access information in the PTT cache 15. The MMU 10 extracts a (k+1)-th page number corresponding to a bit lower than the k-th page number in the virtual address. The MMU 10 accesses a (k+2)-th level page table using the base address of the (k+1)-th level page table and the (k+1)-th page number.

The above-described procedure is repeated until an N-th page number is reached. The N-th page number leads the base address of a physical page. The physical address corresponding to the virtual address is obtained using a page offset in the physical page.

When the MMU 10 accesses a page table again, even though the page table walk is carried out, the number of accesses to the memory 110 is reduced because information about a next level page table can be obtained from the PTT cache 15 that has stored the initial access information of the current page table. Consequently, the PTT cache 15 makes it possible to reduce TLB miss handling overhead caused by real-time constraint such as frame discontinuity due to a stall occurring in a multimedia intellectual property (IP) when the memory 110 is accessed.

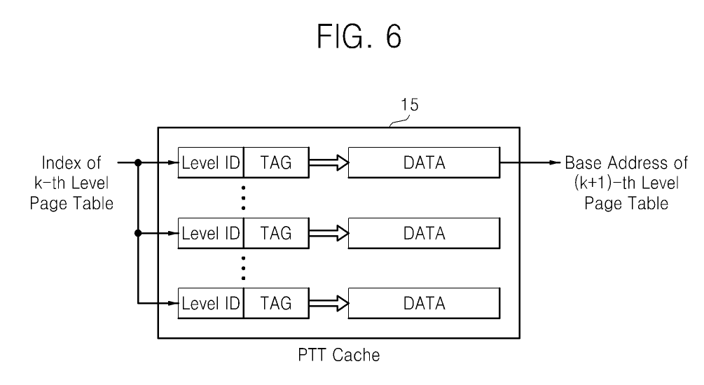

FIG. 6 is a detailed block diagram of the PTT cache 15 illustrated in FIGS. 4A and 4B according to an embodiment of the inventive concept.

Referring to FIG. 6, the access information of the k-th level page table stored in the PTT cache 15 includes a level ID, tag and data.

The level ID is several bits (e.g., at least one bit) in length and indicates the position of a level. For instance, when there are four level page tables, the level ID may be composed of two bits. When there are eight level page tables, the level ID may be composed of three bits.

The tag is an index of the k-th level page table and is mapped to the k-th page number in the virtual address. The tag is used in a fully associative method. Accordingly, when one of a plurality of tags is known, access information of a page table at a level corresponding to the tag is acquired, the access information leads to a next tag, and access information of a page table at a next level is acquired.

The data stores base addresses of multiple level page tables. The PTT cache 15 checks whether there is a tag matching the k-th page number in the virtual address. When it is confirmed that the tag matching the k-th page number exists (i.e., when it is a PTT cache hit), the PTT cache 15 provides the base address of a next level page table mapped to the tag, i.e., the base address of the (k+1)-th level page table.

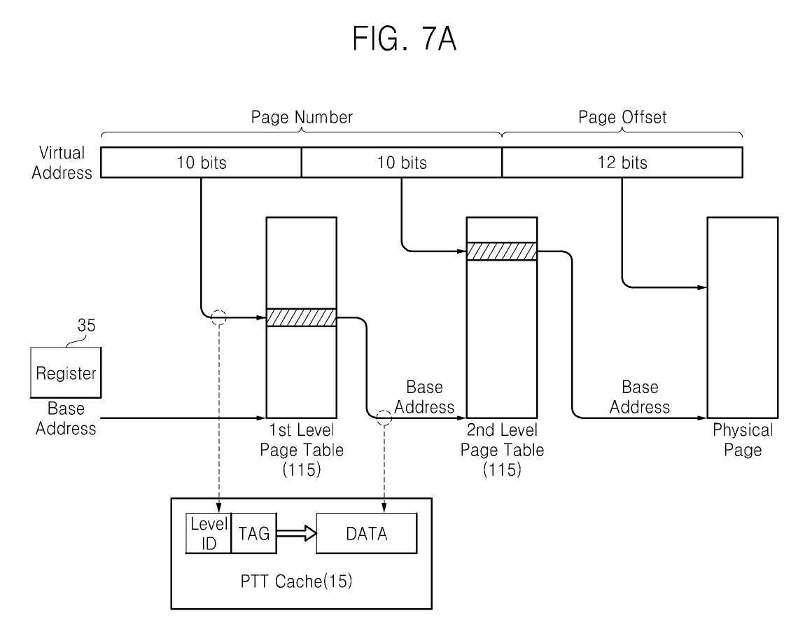

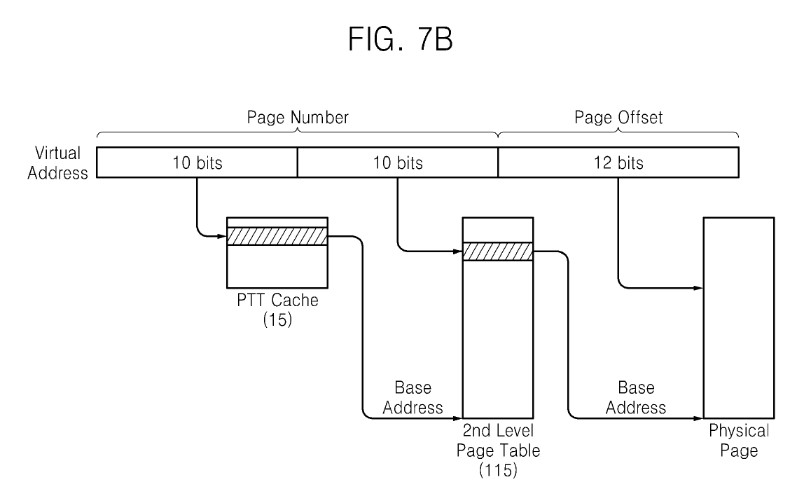

FIG. 7A is a conceptual diagram for explaining the operation principle of the PTT cache 15 illustrated in FIGS. 4A and 4B according to other embodiments of the inventive concept. FIG. 7B is a conceptual diagram for explaining the operation principle of the PTT cache 15 illustrated in FIGS. 4A and 4B according to further embodiments of the inventive concept.

FIGS. 7A and 7B show a two-level page table structure in which a page has a size of 4 KB. It is assumed that the virtual address is 32 bits in length, a page number is 20 bits in length, and a page offset is 12 bits in length. However, the inventive concept is not restricted to the current embodiments.

When a program sequence requests the MMU 10 for the access of a virtual address through the CPU 3, the MMU 10 accesses the TLB 12 to translate the virtual address to a physical address. When translation information of the virtual address is not in the TLB 12, a page table walk is carried out.

When initially accessing a page table, the MMU 10 acquires a base address of a first level page table from the register 35. The MMU 10 recognizes 10 bits starting from the first bit of the virtual address as a first page number, bits from the 11th bit to the 20th bit in the virtual address as a second page number, and bits from 21st bit to the last bit in the virtual address as a page offset. The MMU 10 accesses the first level page table using the base address and then acquires a base address of a second level page table from the first level page table using the second page number. The second level page table provides a base address of a physical page using the second page number. Then, the MMU 10 acquires the physical address to which the virtual address is mapped using the 12-bit page offset.

At this time, the PTT cache 15 stores a record about the access to the first level page table. In other words, the PTT cache 15 stores access information including the first page number, the level ID of the first level and the base address of the second level page table.

The base address covers an area of 2²² bytes, i.e., 4 MB in the first level page table. All 4 KB-pages in the area of 4 MB have the same base address of the first level page table. Accordingly, if the base address of the first level page table is cached, two memory accesses occur once in 1024 times and one memory access occurs 1023 in 1024 times even when only sequential address accesses are considered.

When the MMU 10 accesses the same page table again as shown in FIG. 7B, it checks the PTT cache 15 first to extract the access information of the first level page table from the PTT cache 15 and accesses the memory 110 only to access the second level page table. In other words, when the PTT cache 15 is used, a stall cycle caused by the TLB miss of the MMU 10 is significantly reduced.

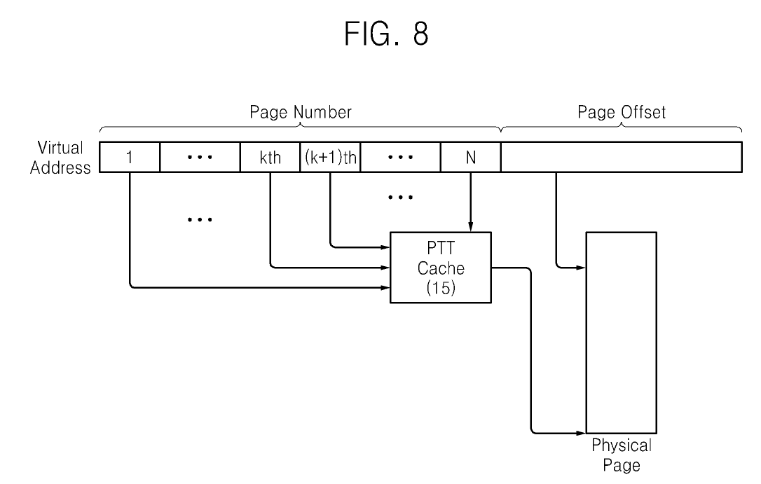

FIG. 8 is a conceptual diagram for explaining the operation principle of the PTT cache 15 illustrated in FIGS. 4A and 4B according to yet other embodiments of the inventive concept.

Referring to FIG. 8, a virtual address is composed of several bits including page numbers respectively corresponding to N levels and a page offset.

Whenever accessing each level page table, the PTT cache 15 stores access information of the current level page table. The access information is arrayed in a fully associative method using tags.

Before accessing the page table 115 using a page number corresponding to each level in the virtual address, the MMU 10 checks whether there is a tag of a certain level page table in the PTT cache 15.

When there is the tag in the PTT cache 15, the PTT cache 15 checks access information of the certain level (e.g., k-th level) page table and provides a base address of the next level (e.g., the (k+1)-th level) page table. At this time, since tags are configured in the fully associative method, a base address of a next level (e.g., the (k+2)-th level) page table is acquired using the base address of the (k+1)-th level page table and a page number corresponding to a next level (e.g., the (k+1)-th page number) in the virtual address.

Through this procedure, the MMU 10 acquires a base address of a physical page from the PTT cache 15 sequentially using first through N-th page numbers in the virtual address. Thereafter, the MMU 10 acquires a physical address corresponding to the virtual address from the physical page using the page offset.

According to the current embodiments of the inventive concept, when the PTT cache 15 is used, the number of accesses to the memory 110 is minimized, thereby minimizing TLB miss handling overhead. In addition, performance deterioration that may occur in a multimedia IP when a system-on-chip (SoC) or an embedded system is maintained for a long time is also minimized using the PTT cache 15.

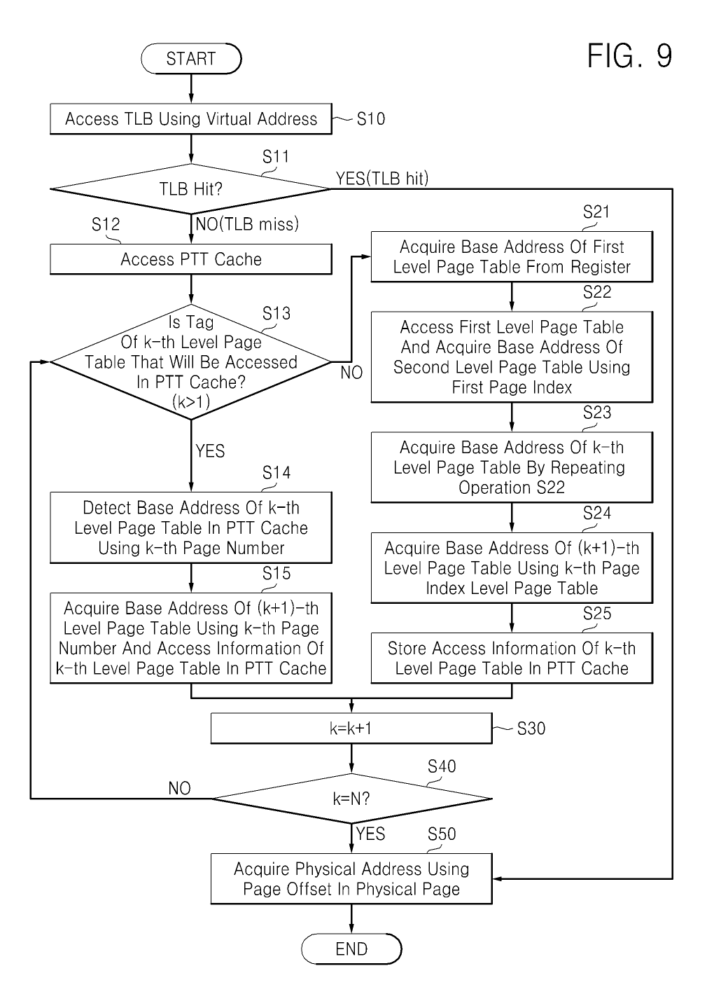

FIG. 9 is a flowchart for use in describing a method of operating the MMU 10 illustrated in FIGS. 4A and 4B according to some embodiments of the inventive concept.

The translation from a virtual address into a physical address by the MMU 10 will be described with reference to FIGS. 1 through 6.

When a program sequence requests the MMU 10 for the access of a virtual address through the CPU 3, the MMU 10 accesses the TLB 12 for translation from the virtual address into the physical address in operation S10. When translation information of the virtual address is in the TLB 12, that is, when it is a TLB hit in operation S11, the MMU 10 translates the virtual address into the physical address to which the virtual address is mapped in operation S50.

However, when the translation information is not in the TLB 12, a page table walk is carried out. Before carrying out the page table walk, the MMU 10 accesses the PTT cache 15 in operation S12 and checks whether a tag of a certain level page table that will be accessed using the virtual address is in the PTT cache 15 in operation S13. When, for example, a k-th level page table is accessed, a base address of the k-th level page table is detected in the PTT cache 15 using a k-th page number in operation S14. At this time, “k” is a natural number greater than 1 and smaller than N.

When the based address of the k-th level page table is detected, a base address of a next level, i.e., (k+1)-th level page table is acquired using the k-th page number and access information of the k-th level page table in the PTT cache 15 in operation S15.

When the tag of the k-th level page table is not in the PTT cache 15 in operation S13, the MMU 10 acquires a base address of a first level page table from the register 35 in operation S21. The MMU 10 accesses second through k-th level page tables sequentially using page numbers, thereby acquiring the base address of the k-th level page table in operations S22 and S23. The MMU 10 accesses the k-th level page table using the base address and acquires a base address of the (k+1)-th level page table using the k-th page number in operation S24. The PTT cache 15 stores access information acquired by accessing the k-th level page table, i.e., the access information of the k-th level page table in operation S25, so that the access information is used when the same page table is accessed again afterwards.

When a physical page is accessed by increasing “k” to N in operations S30 and S40 through the above-described operations, the MMU 10 acquires the physical address from the physical page using a page offset in operation S50.

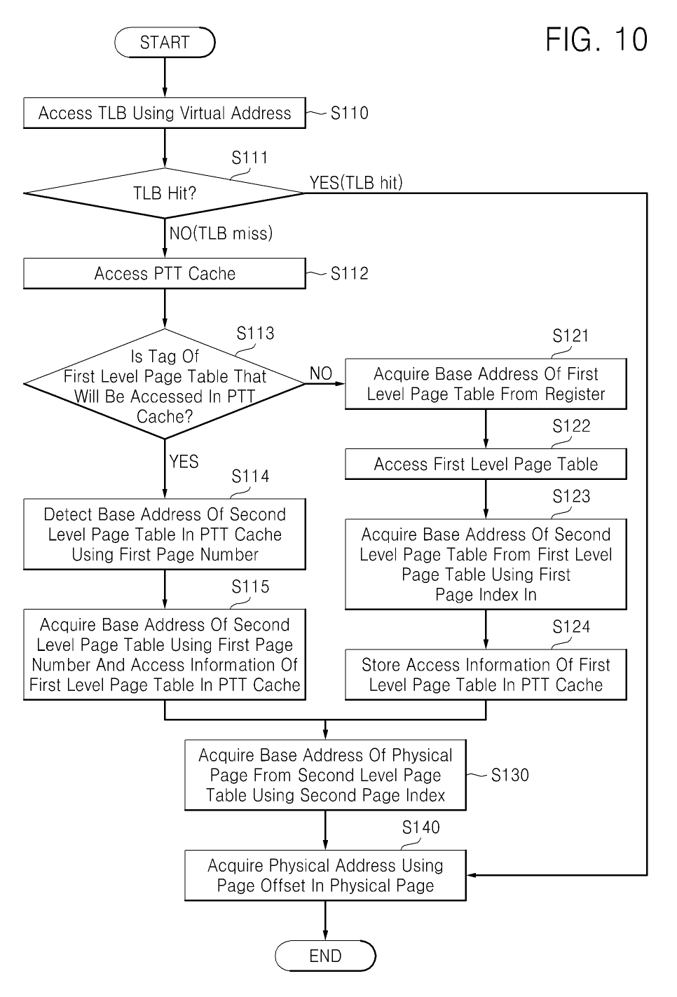

FIG. 10 is a flowchart for use in describing the method of operating the MMU 10 that is illustrated in FIG. 7B. It is assumed that the page table 115 has a two-level structure and a page has a size of 4 KB.

When a program sequence requests the MMU 10 for the access of a virtual address through the CPU 3, the MMU 10 accesses the TLB 12 for translation from the virtual address into a physical address in operation S110. When translation information of the virtual address is in the TLB 12, that is, when it is a TLB hit in operation S111, the MMU 10 translates the virtual address into the physical address to which the virtual address is mapped in operation S140.

However, when the translation information is not in the TLB 12, a page table walk is carried out. Before carrying out the page table walk, the MMU 10 accesses the PTT cache 15 in operation S112 and checks whether a tag of a certain level page table that will be accessed using the virtual address is in the PTT cache 15 in operation S113. When, for example, the first level page table is accessed, a base address of the first level page table is detected in the PTT cache 15 using a first page number in operation S114.

When the based address of the first level page table is detected, a base address of the second level page table is acquired using the first page number and access information of the first level page table in the PTT cache 15 in operation S115.

When the tag of the first level page table is not in the PTT cache 15 in operation S113, the MMU 10 acquires the base address of the first level page table from the register 35 in operation S121 and then accesses the first level page table in operation S122. The MMU 10 recognizes as a second page number lower bits following bits corresponding to the first page number among upper bits of the virtual address and acquires the base address of the second level page table from the first level page table using the second page number in operation S123. The PTT cache 15 stores access information acquired by accessing the first level page table, i.e., the access information of the first level page table in operation S124, so that the access information is used when the same page table is accessed again afterwards.

The MMU 10 accesses a physical page using the second page number from the second level page table in operation S130 and acquires the physical address from the physical page using a page offset in operation S140.

The MMU 10, the page table 115 and the CPU 3 may be implemented in a single chip. The single chip may be separated from the processor 1.

The method of operating an MMU according to some embodiments of the inventive concept can be embodied as program instructions that can be executed using various types of computers and recorded in a computer readable medium. The computer readable medium may include a program instruction, a data file, or a data structure individually or a combination thereof. The program instruction recorded in the medium may be specially designed and configured for the inventive concept or may have already been known to and available to those of skill in the art of computer software. Examples of the computer readable medium include magnetic media such as hard disks, floppy disks and magnetic tapes; optical media such as CD-ROMs and DVDs; magneto-optical media such as floptical disks; and hardware devices such as read-only memory (ROM) devices, random-access memory (RAM) devices and flash memory devices that are specially configured to store and execute program instructions. Examples of the program instruction include machine codes created by a compiler and high-level language codes that can be executed in a computer using an interpreter. The hardware devices may be embodied as at least one software module configured to perform operations according to some embodiments of the inventive concept.

The inventive concept is not restricted to the above-described embodiments. For example, in other embodiments, an MMU, a page table and a PTT cache that are the same as those included in the processor 1 may be additionally included in the graphics engine within the multimedia acceleration unit 60.

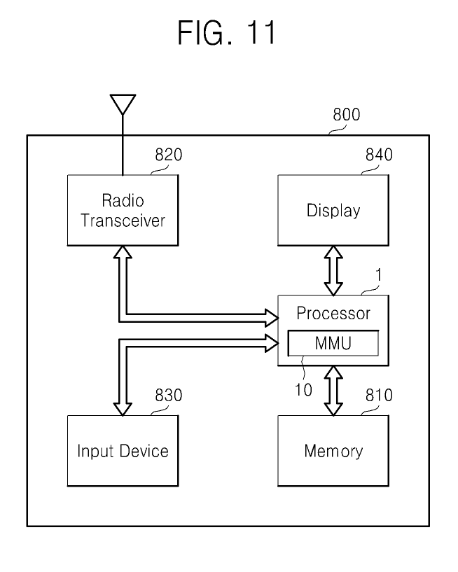

FIG. 11 is a diagram of an electronic apparatus 800 including the MMU 10 illustrated in FIG. 1 according to other embodiments of the inventive concept.

Referring to FIG. 11, the electronic apparatus 800 may be implemented as a cellular phone, a smart phone or a radio communication system. The electronic apparatus 800 includes the processor 1 illustrated in FIG. 1.

The processor 1 includes the MMU 10 according to some embodiments of the inventive concept.

The MMU 10 translates a virtual address into a physical address. The processor 1 accesses the physical address in a memory 810 and reads data from or writes data to the physical address in the memory 810.

The MMU 10, the page table 115 and the CPU 3 may be implemented in a single chip. In addition, the single chip may be separated from the processor 1.

A radio transceiver 820 transmits or receives radio signals through an antenna.

For instance, the radio transceiver 820 may convert radio signals received through the antenna into signals that can be processed by the processor 1. Accordingly, the processor 1 processes the signals output from the radio transceiver 820, translates a virtual address into a physical address and stores the processed signals in the memory 810 as data.

The processed signals may be displayed through a display 840.

The page table 115 may be included in the memory 810, but the inventive concept is not restricted to the current embodiments. The page table 115 may be included in the cache 5 within the processor 1.

The radio transceiver 820 may also convert signals output from the processor 1 into radio signals and outputs the radio signals to an external device through the antenna.

An input device 830 enables control signals for controlling the operation of the processor 1 or data to be processed by the processor 1 to be input to the electronic apparatus 800. The input device 830 is not limited, and examples thereof include a keypad, a keyboard, and point-and-touch devices such as a touch pad and a computer mouse.

The processor 1 may control the operation of the display 840 to display data output from the memory 810, radio signals output from the radio transceiver 820, or data output from the input device 830.

The inventive concept is not restricted to the above-described embodiments. For example, in other embodiments, an MMU, a page table and a PTT cache that are the same as those included in the processor 1 may be additionally included in the graphics engine within the multimedia acceleration unit 60.

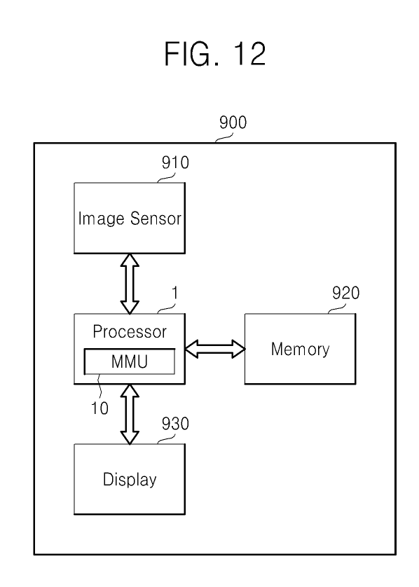

FIG. 12 is a diagram of an electronic apparatus 900 including the MMU 10 illustrated in FIG. 1 according to further embodiments of the inventive concept.

Referring to FIG. 12, the electronic apparatus 900 includes the processor 1 controlling the overall operation of the electronic apparatus 900.

The processor 1 includes the MMU 10.

The MMU 10, the page table 115 and the CPU 3 may be implemented in a single chip. In addition, the single chip may be separated from the processor 1.

An image sensor 910 included in the electronic apparatus 900 converts optical images into digital signals. The processor 1 processes the digital signals based on a virtual address to generate data, translates the virtual address into a physical address using the MMU 10, and stores the data at the physical address in a memory 920.

The page table 115 may be included in the memory 810, but the inventive concept is not restricted to the current embodiments. The page table 115 may be included in the cache 5 within the processor 1.

The inventive concept is not restricted to the above-described embodiments. For example, in other embodiments, an MMU, a page table and a PTT cache that are the same as those included in the processor 1 may be additionally included in the graphics engine within the multimedia acceleration unit 60.

The data stored in the memory 920 is displayed through a display 930 under the control of the processor 1. In other words, the processor 1 translates the virtual address into the physical address using the MMU 10, accesses the physical address of the memory 920, and reads the data from the physical address of the memory 920. The data that has been read is displayed through the display 930.

As described above, according to some embodiments of the inventive concept, an additional cache is provided in an MMU, thereby minimizing performance deterioration that may occur when a TLB miss is processed.

While the inventive concept has been particularly shown and described with reference to exemplary embodiments thereof, it will be understood by those of ordinary skill in the art that various changes in forms and details may be made therein without departing from the spirit and scope of the inventive concept as defined by the following claims.

What is claimed is:

1. A method of operating a memory management unit which accesses an N-level page table of a memory, where N is a plural integer, the method comprising:
accessing a translation lookaside buffer (TLB);
translating a page number of a virtual address into a frame number of a physical address when there is a match for the page number of the virtual address in the TLB;
executing a miss process when there is no match for the page number of the virtual address in the TLB, the miss process including:
accessing a page table translation (PTT) cache;
checking whether access information of a k-th level page table corresponding to a k-th page number that will be accessed in the virtual address is in the PTT cache, where k is an integer and 1>k≧N;
acquiring a base address of a physical page using the access information; and
determining the frame number of physical address corresponding to the page number of the virtual address using a page offset in the physical page.

2. The method of claim 1, wherein said checking comprises acquiring a base address of a (k+1)-th level page table using the access information of the k-th level page table corresponding to the k-th page number in the virtual address when the access information of the k-th level page table is in the PTT cache.

3. The method of claim 1, wherein said checking comprises:
when the access information of the k-th level page table is not in the PTT cache, acquiring a base address of a first level page table from a register; and
sequentially accessing first through k-th level page tables using first through k-th page numbers in the virtual address; and
acquiring the base address of the (k+1)-th level page table from the k-th level page table using the k-th page number.

4. The method of claim 3, wherein said checking further comprises storing the access information of the k-th level page table in the PTT cache.

5. The method of claim 1, wherein the access information comprises a level ID of the k-th level page table, a tag corresponding to an index of the k-th level page table, and data corresponding to the base address of the (k+1)-th level page table.

6. The method of claim 5, wherein the tag of the access information is fully associative.

7. The method of claim 1, wherein said acquiring the base address of the physical page comprises:
acquiring a base address of a next level page table from access information of a current level page table when a level of the N-level page table sequentially increases by 1 from 1 to N in the PTT cache; and
acquiring the base address of the physical page from access information of an N-th level page table using an N-th page number in the virtual address.

8. The method of claim 1, wherein said acquiring the base address of the physical page comprises:
acquiring the access information of the k-th level page table from the PTT cache and acquiring a base address of a (k+1)-th level page table using the access information;
acquiring a base address of a next level page table by accessing a current level page table whenever a level of the N-level page table sequentially increases by 1 from (k+1) to N; and
acquiring the base address of the physical page using an N-th level page table and an N-th page number in the virtual address.

9. The method of claim 1, wherein the memory including the N-level page table is an instruction memory.

10. The method of claim 1, wherein the memory including the N-level page table is a cache memory.

11. A computer readable recording medium storing a program configured to execute the method of claim 1.

12. A memory management unit which accesses an N-level page table of a memory, where N is a plural integer, the memory management unit comprising:
a table lookaside buffer (TLB) configured to translate a page number of a virtual address into a frame number of a physical address when the TLB includes a match for the page number of the virtual address; and
a page table translation (PTT) cache configured to provide access information of a k-th level page table corresponding to a k-th page number to enable a physical page including the physical address to be accessed when the TLB does not include a match for the page number of the virtual address, where k is an integer and 1>k≧N.

13. The memory management unit of claim 12, wherein the PTT cache is configured to check whether access information of a k-th level page table corresponding to a k-th page number that will be accessed in the virtual address is in the PTT cache, acquire a base address of a physical page using the access information, and determine the frame number of physical address corresponding to the page number of the virtual address using a page offset in the physical page.

14. The memory management unit of claim 13, wherein the PTT cache is further configured to, when the access information of the k-th level page table is not in the PTT cache, acquires a base address of a first level page table from a register, sequentially accesses first through k-th level page tables using first through k-th page numbers in the virtual address, stores the access information of the k-th level page table, and then provides the access information.

15. The memory management unit of claim 12, wherein the access information comprises a level ID of the k-th level page table, a tag corresponding to an index of the k-th level page table, and data corresponding to the base address of the (k+1)-th level page table.

16. The memory management unit of claim 15, wherein the tag of the access information is fully associative.

17. An electronic apparatus comprising:
a central processing unit (CPU) configured to request an access to a virtual address for execution of a program sequence;
a multi-level page table configured to store information indicative of a mapping between the virtual address and a physical address; and
a memory management unit,
wherein the memory management unit translates the virtual address into the physical address using an N-level page table, and wherein the memory management unit comprises:
a table lookaside buffer (TLB) configured to translate a page number of the virtual address into a frame number of the physical address when the TLB includes a match for the page number of the virtual address; and
a page table translation (PTT) cache configured to provide access information of a k-th level page table corresponding to a k-th page number to enable a physical page including the physical address to be accessed when the TLB does not include a match for the page number of the virtual address, where k is an integer and 1>k≧N.

18. The electronic apparatus of claim 17, further comprising a cache memory operationally connected to the CPU in parallel with the memory management unit,
wherein the multi-level page table is stored in an instruction memory.

19. The electronic apparatus of claim 17, further comprising a cache memory operationally connected to the CPU in parallel with the memory management unit,
wherein the multi-level page table is stored in the cache memory.

20. The electronic apparatus of claim 17, wherein the PTT cache is configured to check whether access information of a k-th level page table corresponding to a k-th page number that will be accessed in the virtual address is in the PTT cache, acquire a base address of a physical page using the access information, and determine the frame number of physical address corresponding to the page number of the virtual address using a page offset in the physical page.
